(19) United States
(12) Patent Application Publication
(10) Pub. No.: US 2024/0293825 A1
(43) Pub. Date: Sep. 5, 2024

(54) BOLTING ASSEMBLY FOR CONE CRUSHER

(71) Applicant: SANDVIK SRP AB, Svedala (SE)

(72) Inventors: Johan GUNNARSSON, Svedala (SE); Sukrija DAUTOVIC, Svedala (SE)

(21) Appl. No.: 18/572,267

(22) PCT Filed: Jun. 21, 2022
(86) PCT No.: PCT/EP2022/066840

§ 371 Date: Dec. 20, 2023

(30) Foreign Application Priority Data
Jun. 21, 2021 (EP) 21180522.1

(51) Int. Cl. B02C 2/04

(52) U.S. Cl. CPC B02C 2/04

(57) ABSTRACT

A bolting assembly for a cone crusher is provided. The bolting assembly is arranged for securing a frame top part to a frame bottom part of the crusher, and includes a stem centered around a longitudinal axis, and a sleeve centered around the longitudinal axis and arranged around the stem, wherein the sleeve is arranged in the frame top part. A cone crusher including the bolting assembly is also described.

### FIELD OF INVENTION

The present invention relates to a bolting assembly for a cone crusher. Further the present invention relates to a cone crusher.

### BACKGROUND

Cone crushers are used for crushing ore, mineral and rock material to smaller sizes. A gyratory crusher is an example of a cone crusher. Typically, an inner crushing shell is mounted on the crushing head. An outer crushing shell is mounted on the frame top part. A crushing gap is formed between the two crushing shells. When the crusher operates material is crushed between the inner crushing shell and the outer crushing shell. This is the result of the gyrating movement of the crushing head, during which movement the two crushing shells approach one another along a rotating generatrix and move away from one another along a diametrically opposed generatrix.

The top part of the cone crusher frame is connected to a frame bottom part. This connection is commonly secured by arranging bolts so that the frame top part and frame bottom part stay in place and are closely connected. A collar is arranged at the bottom end of the frame top part and the upper end of the frame bottom part, respectively. Through holes in the collars host these retaining bolts. In addition to these bolts the collar of the frame top part comprises through holes for bolts, which are used when the frame top and bottom part are to be disconnected. These are referred to as push bolts. A cone crusing with this type of bolting assembly is described in U.S. Pat. No. 3,837,585.

However, in the environment where the cone crusher is used the threads in the frame in connection to the bolts might become corrosive, leading to that the force from the bolts being limited and thus not functioning properly. After a certain time of use of the crusher the threads get worn, and also in this case the force from the bolts will thus be reduced so that separating the frame parts become cumbersome. In order to repair worn out threads the frame top part needs to be welded and the holes need to be re-threaded. This is often done in a repair center, meaning that the part needs to be sent away. Therefore, it is both time consuming and costly to make worn out threads function properly together with the bolts.

Thus, there is a need to make the threads better withstand wear and to last longer. Further, there is also a need to avoid longer downtime.

Thus, what is required is a bolting assembly and a cone crusher that addresses the above problems.

### SUMMARY

It is an object of the present invention to provide a bolting assembly for a cone crusher to bolt a top frame part to a bottom frame part and that can be used longer than existing solutions. Another object is to have a bolting assembly that is not worn out quickly. And yet a further object is a supporting system when disassembling a cone crusher's frame top part from its frame bottom part that is easy to use and requires less force than in existing solutions.

According to a first aspect of the present invention, there is provided a bolting assembly for a cone crusher, wherein the bolting assembly comprises a stem centred around a longitudinal axis, and a sleeve centred around the longitudinal axis and arranged around the stem. The provision of a sleeve for the stem allows the sleeve to be designed to be detached from the frame top part when the bolt is being disconnected. Thus, with the bolting assembly of the invention, if threads on the stem and sleeve have been deformed and worn, the stem and sleeve can be removed and replaced, as opposed to having to replace the entire collar of the frame top part. This means that the material of the frame top part itself does not need to be replaced as often as with today's construction. So, the objectives are achieved by an additional piece of material in connection to the body of the frame top part.

In any embodiment, the bolting assembly is configured for mounting in a through hole in a collar of the frame top part and for connection to a collar of the frame bottom part, and wherein the sleeve is arranged in the frame top part.

In any embodiment, the sleeve is a cylinder with an upper part comprising an outer perimeter being uniform in the longitudinal direction, and wherein a lower end comprising a larger outer perimeter in comparison to the upper part. Thereby the bolting assembly will be locked in longitudinal axial direction.

In any embodiment, the sleeve comprises an asymmetrical shape of the perimeter at the lower end.

Thereby will also be achieved that the bolting assembly is locked against rotation.

In any embodiment, the lower end of the sleeve has a length seen in the longitudinal direction being 5 to 20% of the entire longitudinal length of the sleeve. In any embodiment, the lower end of the sleeve may be 8, 10, 12, 15 or 18% of the entire longitudinal length of the sleeve. This gives an efficient locking with a limited extra amount of material added to the sleeve.

In any embodiment, the sleeve comprises a thread arranged on an inner diameter to be in threaded engagement with the stem. This allows for the stem and the sleeve to be connected and disconnected to each other in a simple and easy to use manner.

In any embodiment, the assembly comprises a holding nut arranged in connection to the sleeve.

According to a third aspect of the present invention, there is provided a push-bolt assembly for a cone crusher, the push bolt assembly comprising:
a push-bolt comprising a stem centred around a longitudinal axis (X); and
a sleeve centred around the longitudinal axis (X) and arranged around the stem,
wherein the push bolt assembly is configured for mounting in a through hole in a collar of the frame top part and wherein the stem is configured for connection to (or abutting against) against a collar of the frame bottom part, and wherein the sleeve is arranged in the frame top part.

In any embodiment, the push bolt comprises a hydraulic tool actuatable to move the push bolt axially through the sleeve.

In any embodiment, and wherein the assembly comprises a push bolt. This is an efficient and simple solution is a bolt that is configured to separate the frame top part and frame bottom part when actuated.

In any embodiment, the assembly comprises a hydraulic tool. The hydraulic tool is generally arranged in connection to the stem such that the hydraulic tool acts on the stem in the longitudinal direction. This leads to less force required to be applied by the operator.

According to a third aspect of the present invention, there is provided a cone crusher comprising a bolting assembly of the invention. The bolting assembly is generally configured for mounting in a through hole arranged in a collar of the frame top part and for connection to a collar of the frame bottom part, and wherein the sleeve is arranged in the frame top part.

In any embodiment, the crusher comprises four to eight bolting assemblies. In any embodiment, the number of bolting assemblies is six. In any embodiment, the bolting assemblies are spread out on the collar at the perimeters of the frame top and bottom parts.

This is to ensure that the frame top and bottom parts can be separated in a smooth way. In any embodiment, the bolting assemblies may also be spread out evenly on the collar, with the same distance between two neighbouring bolting assemblies. An even distribution of the bolting assemblies achieves that an optimal lowest force is needed for separating the two parts.

In any embodiment, the material of the sleeve has a different hardness than the frame top part. So, the material of the sleeve is either harder or softer than the material of the frame top part. The material hardness is generally chosen to fit the needs, i.e. a harder material will make the threads more wear resistant.

### BRIEF DESCRIPTION OF DRAWINGS

A specific implementation of the present invention will now be described by way example only and with reference to the following drawings in which:

FIG. 1 is a cross-sectional side view of a cone crusher;

FIG. 2 is a magnified view of the cross-sectional side view of FIG. 1 with a bolting assembly at the intersection of bottom and top part;

FIG. 3 is a magnified view of the cross-sectional side view of FIG. 1 with a further embodiment of a bolting assembly at the intersection of bottom and top part;

FIG. 4 is a magnified view of the cross-sectional side view of FIG. 1 with a further embodiment of a bolting assembly at the intersection of bottom and top part.

### DETAILED DESCRIPTION

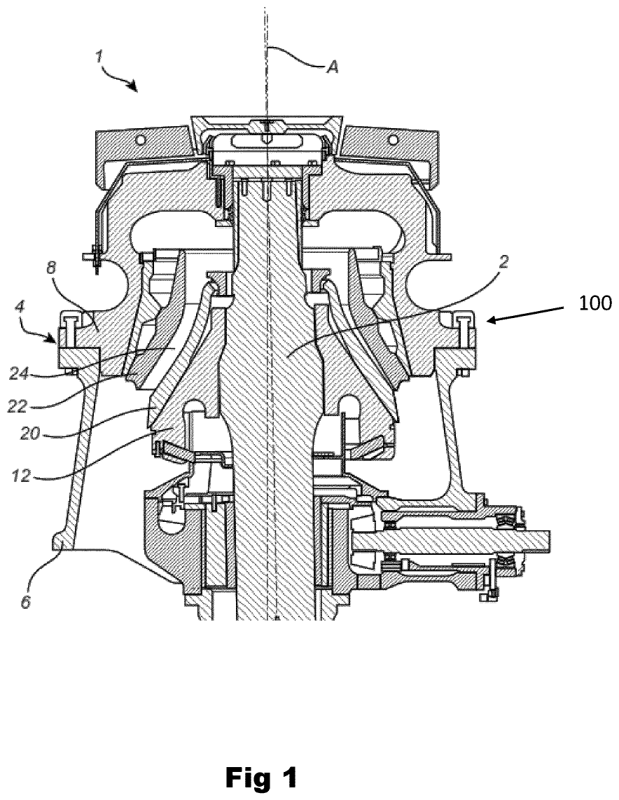

FIG. 1 discloses a cone crusher 1 having a vertical crushing head shaft 2 and a frame 4 with a bottom part 6 and a top part 8. To the upper portion of the head shaft 2 is a crushing head 12 mounted.

The crusher 1 has a central axis A. An eccentric sleeve is arranged around the lower portion of the head shaft 2. A drive shaft is arranged to rotate the eccentric sleeve by means of a motor (not shown) and a gear rim mounted on the eccentric sleeve. When the crusher operates the drive shaft rotates the eccentric sleeve so the crushing head shaft and the crushing head will execute a gyrating movement.

An inner crushing shell 20 is mounted on the crushing head 12. An outer crushing shell 22 is mounted on the frame top part 8. A crushing gap 24 is formed between the two crushing shells 20, 22. When the crusher 1 operates material is crushed between the inner crushing shell 20 and the outer crushing shell 22. This is the result of the gyrating movement of the crushing head 12, during which movement the two crushing shells approach one another along a rotating generatrix and move away from one another along a diametrically opposed generatrix.

In a collar in the frame top part 8 bolting assemblies 100 are arranged. They are spread out around the collar. When top and bottom frame parts 6, 8 are to be taken apart these bolting assemblies 100 assist.

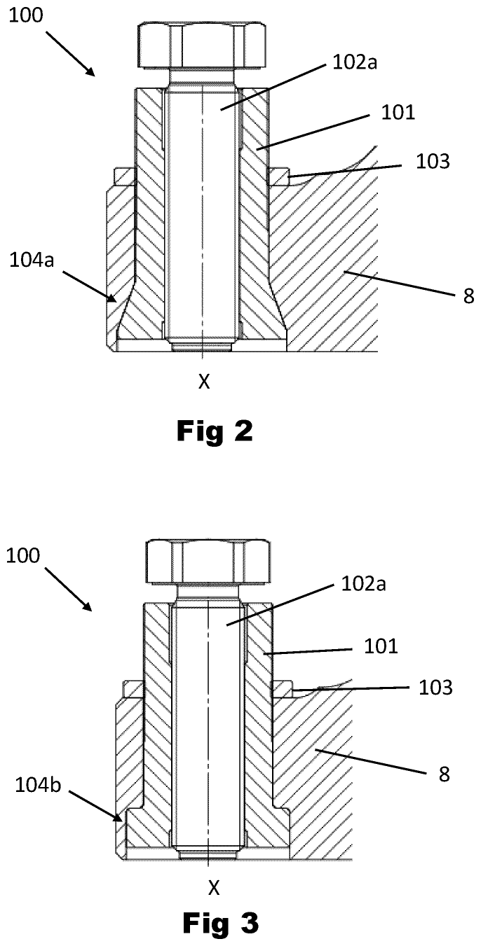

FIGS. 2 and 3 disclose a bolting assembly 100 at the intersection of bottom and top part, and being arranged in the frame top part 8. A sleeve 101 is arranged around a threaded and cylindrical stem 102a. The sleeve 101 has both a threaded inside and outside and a holding nut 103 is arranged at its outer end. Both the sleeve 101 and the stem 102a are centred around a longitudinal axis X. The sleeve 101 is a cylinder and its outer contour can be round, oval or a polygon with a certain number of edges and sides such as 6 to 8.

The cylindrical sleeve 101 has a uniform outer diameter throughout most of its length. The exception to its regular shape is a lower end 104a, 104b that has a greater outer diameter and perimeter than the rest of the sleeve. The lower end 104a, 104b is also referred to as a foot.

As disclosed in FIG. 2 the foot can have a mainly conical shape connecting to the cylindrical part of the sleeve. The outermost lower end, i.e. the sleeve seen from below can have an outer perimeter being round, oval or a polygon such that it has a similar outer contour as the rest of the cylinder yet in a larger format, or it can have a different shape than the cross section of the upper part of the sleeve. This version of the lower end 104a is defined to comprise an asymmetrical shape of the perimeter with a combination of cone in connection to the upper part of the sleeve and with a cylindrical outermost lower end.

FIG. 3 discloses another version of the lower end 104b having a sharp step seen from the side wherein the foot has a uniform cylindrical extension. The outer perimeter of the lower end 104b can be round, oval or a polygon such that it has a similar outer contour as the rest of the cylinder yet in a larger format, or it can have a different shape than the cross section of the upper part of the sleeve. Also, the version of the lower end 104b seen in FIG. 3 can comprise an asymmetrical shape of the perimeter such as a polygon with one or more sides being round.

The lower end 104a, 104b has a longitudinal length following the longitudinal axis X that is approximately 1/20 to ⅕ of the entire longitudinal length of the sleeve 101. Seen in the cross-sectional direction the outermost lower end has an outer diameter being approximately 1/10 to ⅕ larger than the outer diameter of the upper end of the sleeve 101.

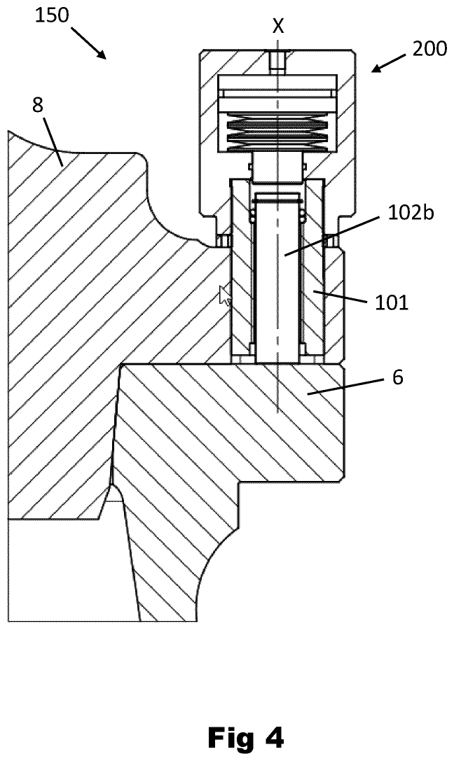

FIG. 4 discloses a push bolt bolting assembly according to a further aspect of the invention and indicated generally by the reference numeral 150 arranged in the frame top part 8, in connection to the frame bottom part 6 and comprising a hydraulic tool 200. The sleeve 101 is arranged around a stem 102b being arranged to connect to the hydraulic tool 200. The stem 102b is a cylinder with a smooth outer surface. The sleeve 101 can be the same embodiment as in FIG. 2 or 3. Hydraulic force is built up in order to push on the outer longitudinal end of the stem, so that the force is transmitted to the frame bottom part 6. In this way the frame top part 8 and the frame bottom part 6 can be separated.

1. A bolting assembly for a cone crusher having a frame top part and a frame bottom part, the bolting assembly comprising:
a stem centred around a longitudinal axis; and
a sleeve centred around the longitudinal axis and arranged around the stem, wherein the bolting assembly is configured for mounting in a through hole in a collar of the frame top part and connection to a collar of the frame bottom part, and wherein the sleeve is arranged in the frame top part, wherein the sleeve is a cylinder with an upper part having an outer perimeter being uniform in the longitudinal direction, and wherein a lower end of the sleeve includes a larger outer perimeter in comparison to the outer perimeter of the upper part.

2. The bolting assembly as claimed in claim 1, wherein the outer perimeter of the lower end of the sleeve has an asymmetrical shape.

3. The bolting assembly as claimed in claim 1, wherein the lower end of the sleeve has a length in the longitudinal direction that is 5 to 20% of an entire longitudinal length of the sleeve.

4. The bolting assembly as claimed in claim 1, wherein the sleeve includes a thread arranged on an inner diameter for threaded engagement with the stem.

5. The bolting assembly as claimed in claim 1, further comprising a holding nut arranged in connection to the sleeve.

6. A cone crusher comprising a bolting assembly as claimed in claim 1, wherein the bolting assembly is arranged in a through hole arranged in a collar of the frame top part and in connection to a collar of the frame bottom part, and wherein the sleeve is arranged in the frame top part.

7. The cone crusher as claimed in claim 6, wherein the crusher includes four to eight bolting assemblies.

8. The cone crusher as claimed in claim 6, wherein the crusher includes six bolting assemblies.

9. The cone crusher as claimed in claim 6, wherein a material of the sleeve has a different hardness than a material of the frame top part.

10. A cone crusher comprising:
a frame top part and a frame bottom part; and
a push-bolt bolting assembly configured to separate the frame top part and the frame bottom part, wherein the push-bolt bolting assembly includes a hydraulic tool.

11. The cone crusher as claimed in claim 10, wherein the push-bolt bolting assembly includes a stem centred around a longitudinal axis, and wherein the hydraulic tool is arranged in connection to the stem such that the hydraulic tool acts on the stem in the longitudinal direction.
